(19) United States
(12) Patent Application Publication
(10) Pub. No.: US 2009/0176481 A1
(43) Pub. Date: Jul. 9, 2009

(54) Providing Location-Based Services (LBS) Through Remote Display

(75) Inventors: Craig Hamilton, Sunnyvale, CA (US); David Daetz, Sunnyvale, CA (US)

Correspondence Address: FENWICK & WEST LLP, SILICON VALLEY CENTER, 801 CALIFORNIA STREET, MOUNTAIN VIEW, CA, 94041, US

(73) Assignee: Palm, Inc., Sunnyvale, CA (US)

(21) Appl. No.: 11/969,867

(22) Filed: Jan. 4, 2008

(51) Int. Cl. H04M 3/42; H04M 1/00

(52) U.S. Cl. 455/414.2; 455/73; 455/550.1

(57) ABSTRACT

Embodiments of the present disclosure include a method (and corresponding system and computer program product) for a mobile computing device to provide location-based services through a peripheral display device. The method includes receiving location-related data at the mobile computing device, establishing a communication connection between the mobile computing device and the peripheral display device. The mobile computing device generates visual data for a location-based service and transmits the visual data to the peripheral display device. The peripheral display device displays the received visual data. The peripheral display device may optionally receive user input and transmit the input to the mobile computing device for process.

### RELATED APPLICATIONS

This application is related to U.S. Pat. No. 6,745,047 issued Jun. 1, 2004, U.S. patent application Ser. No. 10/085,945 filed Feb. 28, 2002, U.S. patent application Ser. No. 10/085,924 filed Feb. 28, 2002, U.S. patent application Ser. No. 09/096,149 filed Nov. 28, 2001, the disclosure of which is hereby incorporated by reference in their entirety.

### BACKGROUND

1. Field of Disclosure

The disclosure generally relates to the field of data communication, in particular to wireless data communication between devices.

2. Description of the Related Art

Numerous products (e.g., built-in Global Positioning System (GPS) devices in automobiles) have been developed to provide drivers with location-based services (e.g., street navigation). However, these products tend to be expensive and, although portable, are still considered bulky.

Mobile phone manufacturers have developed mobile phones with GPS capacity to provide users with location-based services. However, because screens on mobile phones tend to be small in size, drivers frequently find them difficult to use, especially for the purpose of street navigation.

Thus, the art lacks a system and method for mobile computing devices to provide location-based services through peripheral display devices.

### SUMMARY

Embodiments of the present disclosure include a method (and corresponding system and computer program product) for a mobile computing device to provide location-based services through a peripheral display device. The method includes receiving location-related data at the mobile computing device, establishing a communication connection between the mobile computing device and the peripheral display device. The mobile computing device generates visual data for a location-based service and transmits the visual data to the peripheral display device. The peripheral display device displays the received visual data. The peripheral display device may optionally receive user input and transmit the input to the mobile computing device for process.

Advantages of the disclosed embodiments include providing location-based services through user-friendly peripheral display devices. In addition, because mobile computing devices often have access to users' personalized information, they may provide personalized location-based services through the peripheral devices.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying drawings, in which:

FIG. 1 illustrates one embodiment of a mobile computing device.

FIG. 2 illustrates one embodiment of an architecture of a mobile computing device.

FIG. 3 illustrates an example system environment for a mobile computing device to provide a location-based service in a peripheral display device according to one embodiment.

FIG. 4 illustrates one embodiment of an architecture of a peripheral display device.

FIG. 5 is a flowchart illustrating one embodiment of an example method for a computing device to provide a location-based service in a peripheral device.

### DETAILED DESCRIPTION

The Figures and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Mobile Computing Device

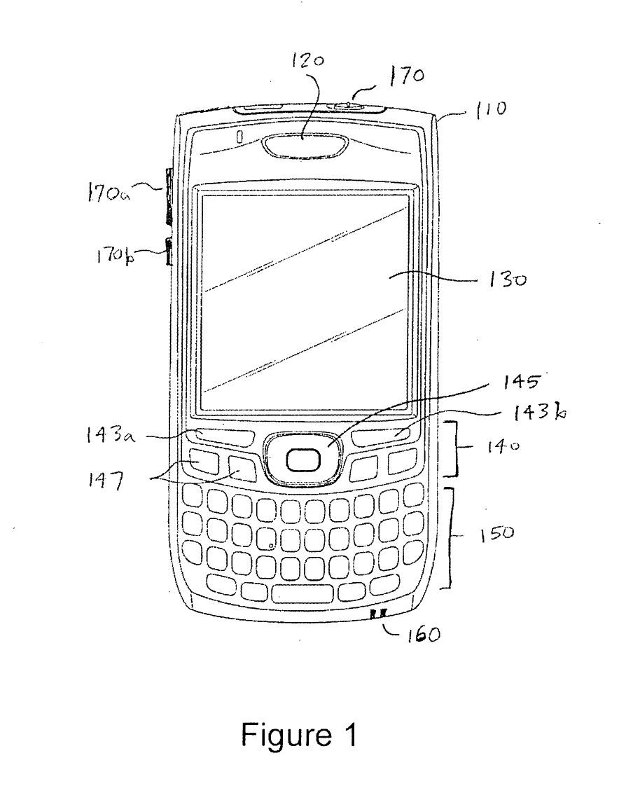

FIG. 1 illustrates one embodiment of a mobile computing device 110 with telephonic functionality, e.g., a mobile phone or a smartphone. The mobile computing device is configured to host and execute a phone application for placing and receiving telephone calls. It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) or data networks having voice over internet protocol (VoIP) functionality. Moreover, the principles disclosed herein may also be applied to other devices, such as personal digital assistants (PDAs), media players and other similar devices.

The mobile computing device 110 is configured to be of a form factor that is convenient to hold in a user's hand, for example, a personal digital assistant (PDA) or a smart phone form factor. For example, in one embodiment the mobile computing device 110 can have dimensions ranging from 7.5 to 15.5 centimeters in length, 5 to 12.75 centimeters in width, 0.64 to 2.2 centimeters in height and weigh between 55 and 230 grams.

The mobile computing device 110 includes a speaker 120, a screen 130, a navigation area 140, a keypad area 150, and a microphone 160. The mobile computing device 110 also may include one or more switches 170, 170a, 170b (generally 170). The one or more switches 170 may be buttons, sliders, or rocker switches and can be mechanical or solid state (e.g., touch sensitive solid state switch).

The screen 130 of the mobile computing device 110 is, for example, a 240×240, a 320×320, or a 320×480 transflective display. For example, the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the screen 130 displays color images. In another embodiment, the screen 130 further comprises a touch-sensitive display (e.g., pressure-sensitive (resistive), electrically sensitive (capacitative), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The navigation area 140 is configured to control functions of an application executing in the mobile computing device 110 and visible through the screen 130. For example, the navigation area includes an x-way (x is e.g., 5) navigation ring (or joystick) 145 that provides cursor control, selection, and similar functionality. In addition, the navigation area 140 may include selection buttons 143a, 143b to select functions viewed just above the buttons on the screen 130. In addition, the navigation area 140 also may include dedicated function buttons 147 for functions such as, for example, a calendar, a web browser, an e-mail client or a home screen. In this example, the navigation ring 145 may be implemented through mechanical, solid state switches, dials, or a combination thereof. The keypad area 150 may be a numeric keypad (e.g., a dial pad) or a numeric keypad integrated with an alpha or alphanumeric keypad (e.g., a keyboard with consecutive keys of QWERTY, AZERTY, or other equivalent set of keys on a keyboard or a Dvorak keyboard).

Although not illustrated, it is noted that the mobile computing device 110 also may include an expansion slot (not shown). The expansion slot is configured to receive and support expansion cards (or media cards), which may include memory cards such as CompactFlash™ cards, SD cards, XD cards, Memory Sticks™, MultiMediaCard™, SDIO, and the like.

The mobile computing device 110 may also include a connector (not shown in FIG. 1) for connections with external computing devices, such as a desktop computer. The connection may be wired (e.g., via a Universal Serial Bus (USB) connection) or wireless (e.g., via a Bluetooth connection). The desktop computer can access and modify data stored in the mobile computing device 110 (e.g., data stored in integrated or embedded storage devices or in expansion cards) through the connection.

### Example Mobile Computing Device Architectural Overview

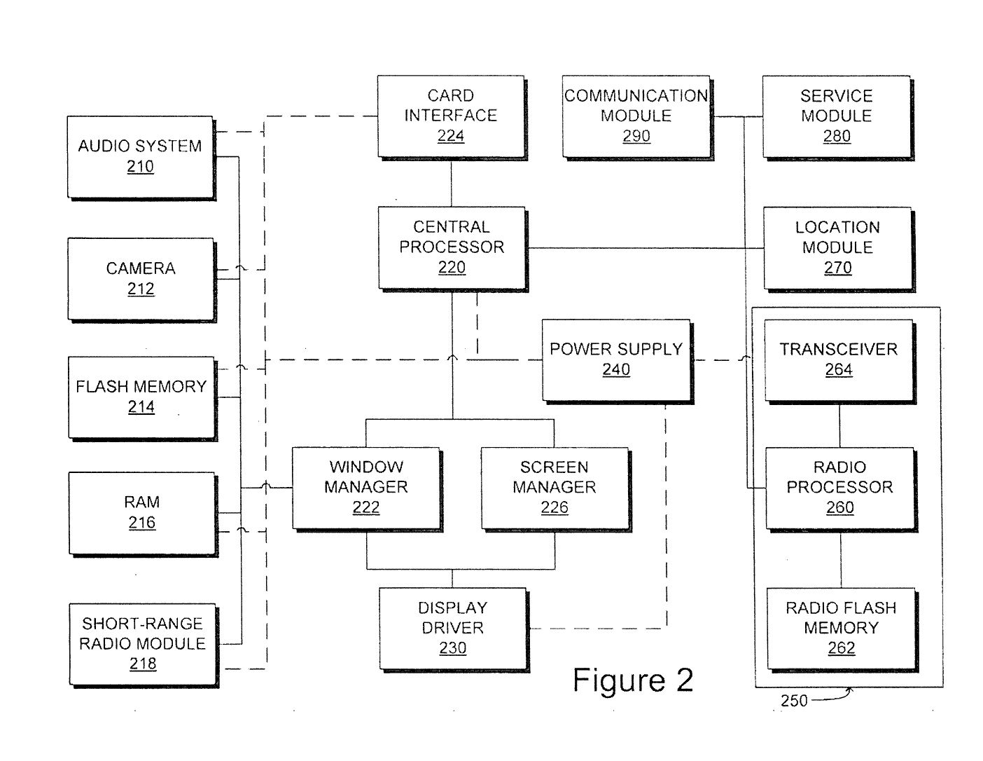

Referring next to FIG. 2, a block diagram illustrates one embodiment of an architecture of a mobile computing device 110 with telephonic functionality. By way of example, the architecture illustrated in FIG. 2 will be described with respect to the mobile computing device of FIG. 1. The mobile computing device 110 includes a central processor 220, a power supply 240, and a radio subsystem 250. The central processor 220 communicates with: audio system 210, camera 212, flash memory 214, random-access memory (RAM) 216, short range radio module 218 (e.g., Bluetooth, Wireless Fidelity (WiFi) component), a window manager 222, a screen manager 226, a location module 270, a service module 280, and a communication module 290. The power supply 240 powers the central processor 220, the radio subsystem 250 and a display driver 230 (which may be contact- or inductive-sensitive). The power supply 240 may correspond to a battery pack (e.g., rechargeable) or a powerline connection or component.

In one embodiment, the window manager 222 comprises a software or firmware instructions for processes that initialize a virtual display space stored in the RAM 216 and/or the flash memory 214. The virtual display space includes one or more applications currently being executed by a user and the current status of the executed applications. The window manager 222 receives requests, from user input or from software or firmware processes, to show a window and determines the initial position of the requested window. Additionally, the window manager 222 receives commands or instructions to display and modify a window, such as resizing the window along one axis, moving the window along one axis or any other command altering the appearance or position of the window, and modifies the window accordingly.

The screen manager 226 comprises a software or firmware instructions for processes that manage content displayed on the screen 130. In one embodiment, the screen manager 226 monitors and controls the physical location of data displayed on the screen 130 and which data is displayed on the screen 130. The screen manager 226 alters or updates the location of data on the screen 130 responsive to input from the central processor 220, to modify the screen 130 appearance. In one embodiment, the screen manager 226 also monitors and controls screen brightness and transmits control signals to the central processor 220 to modify screen brightness and power usage to the screen 130.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120. The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, multiple Access (CDMA system), and a Universal Mobile Telecommunications System (UMTS). Examples of data networks include General Packet Radio Service (GPRS), third-generation (3G) mobile, High Speed Download Packet Access (HSDPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using a serial line 278.

The card interface 224 is adapted to communicate with the expansion slot (not shown). The card interface 224 transmits data and/or instructions between the central processor 220 and an expansion card or media card included in the expansion slot. The card interface 224 also transmits control signals from the central processor 220 to the expansion slot to configure an expansion card or media card included in the expansion slot. In one embodiment, the card interface 224 works with the storage driver 227 in order to transmit data and/or instructions to and/or from the expansion card or media card included in the expansion slot.

In one embodiment, central processor 220 executes logic (by way of programming, code, instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment.

The location module 270 comprises a software or firmware instructions for receiving (or retrieving or accessing) location (or position) related data, such as signals from the Global Positioning System (GPS), Wi-Fi networks, and cellular networks. For example, the location module 270 may include a GPS receiver for receiving GPS signals. The location module 270 uses the signals to determine a geographical position of the mobile computing device 110. For example, the location module 270 may use triangulation (e.g., cellular tower triangulation) to determine the geographical position.

The service module 280 comprises a software or firmware instructions for providing one or more location-based services, such as street navigation service for automobile drivers. The service module 280 receives location (or position) information from the location module 270 and renders the provided service. The service module 280 may retrieve relevant data from local storage (e.g., the flash memory 214) or from external sources (e.g., the Internet). For example, the service module 280 may retrieve maps from online map service providers (e.g., Google™ Maps). In one embodiment, the service module 280 generates visual data (e.g., graphical data, video data) for the location-based services. The generated visual data may be displayed on the screen 130 or peripheral display devices.

The communication module 290 comprises a software or firmware instructions for communicating with peripheral devices. In one embodiment, the communication module 290 may use the short range radio module 218 (or the radio subsystem 250) to discover compatible peripheral devices within transmission range of the short range radio module 218 and establish a communication connection with the discovered peripheral device. The communication module 290 may transmit the visual data generated by the service module 280 to a peripheral display device for display. The communication module 290 may also transmit other data (e.g., audio data) generated by other applications (e.g., a media player) on the mobile computing device 110 to the discovered peripheral device(s). In one embodiment, the communication module 290 may receive signals from the peripheral device (e.g., data or commands).

### System Environment

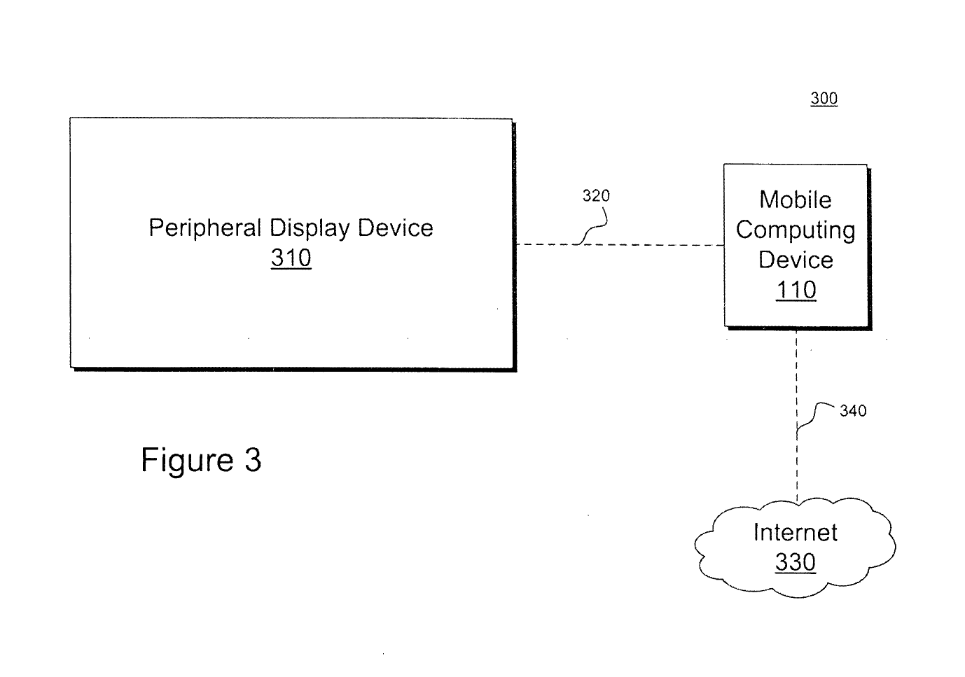

FIG. 3 illustrates an example system environment 300 for a mobile computing device 110 to provide a location-based service in a peripheral display device 310. As illustrated in FIG. 3, the mobile computing device 110 is communicatively connected with the peripheral display device 310 through a communication connection 320. The mobile computing device 110 is also communicatively connected with the Internet 330 through a communication connection 340.

As described above with reference to FIGS. 1 and 2, the mobile computing device 110 provides location-based services such as street navigation service. For example, the mobile computing device 110 have access to map information (e.g., from local storage) and traffic information (e.g., from online traffic information provider, such as Google™ Maps). The mobile computing device 110 may have access to personalized information such as schedule information (e.g., through Microsoft™ Outlook Calendar). The mobile computing device 110 may provide personalized location-based services by utilizing the personalized information. For example, the mobile computing device 110 may proactively provide routing information based on user schedule without user input (e.g., route to SFO airport to catch a scheduled flight).

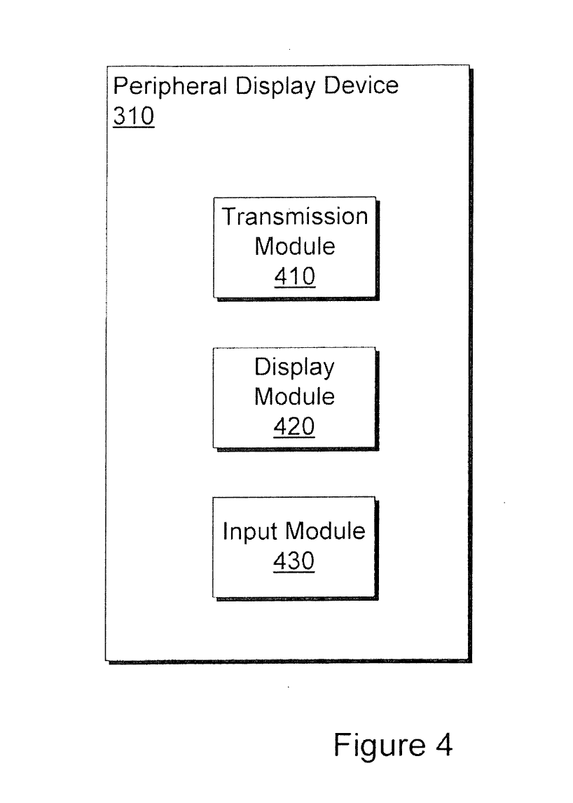

The peripheral display device 310 may be any display device capable of communicating with the mobile computing device 110 and displaying received visual data. One example of the peripheral display device 310 is a LCD display device mounted to a vehicle's dashboard. The peripheral display device 310 may also have access to other output devices such as speakers and LED indicators. An example architecture of the peripheral display device 310 will be described in greater detail below with reference to FIG. 4.

The communication connections 320 and 340 are configured to connect the mobile computing device 110 and the peripheral device 310, and the mobile computing device 110 and the Internet 330, respectively. The communication connections 320 and 340 may be a wired or wireless network. Examples of the communication connections 320 and 340 include a Bluetooth connection, an infrared connection, a WiFi network, a WiMAX network, a mobile telephone network, or a combination thereof.

As noted above, the peripheral display device 310 may be mounted to a vehicle's dashboard. In one embodiment, the peripheral display device 310 and the mobile computing device 110 may be configured to transmit and/or receive data associated with the vehicle through the communication connection 320.

### Example Peripheral Display Device Architectural Overview

FIG. 4 is a block diagram illustrating one embodiment of an architecture of a peripheral display device 310. The peripheral display device 310 includes a transmission module 410, a display module 420, and optionally an input module 430. In one embodiment, the peripheral display device 310 is structured to include a processor, memory, storage, network interfaces, and applicable operating system and other functional software (e.g., network drivers, communication protocols). The peripheral display device 310 also includes (or has access to) a local display (e.g., a LCD screen) and optionally other output devices (e.g., speakers and LED indicators).

In one embodiment, the local display of the peripheral display device 310 has large viewing area and provides user-friendly graphical display. In one embodiment, the local display can have dimensions ranging from 5 to 20 centimeters in length and 10 to 30 centimeters in width. The peripheral display device 310 can weigh between 100 and 5,000 grams. In one embodiment, the peripheral display device 310 includes a mechanical configuration to mount to and/or dismount from a locator (e.g., a vehicle's dashboard).

The transmission module 410 comprises a software or firmware instructions for communicating with a computing device such as the mobile computing device 110. Similar to the communication module 290 of the mobile computing device 110, the transmission module 410 may use a short range radio module (not shown) to conduct the communication. The transmission module 410 receives visual data (e.g., graphical data, video data) from the mobile computing device 110 and forwards (e.g., signals) to the display module 420 for display.

The display module 420 comprises a software or firmware instructions for displaying visual data on a local display. In one embodiment, if the received visual data is not supported (e.g., incompatible resolution and/or format) by the local display, the display module 420 may process the visual data to make it suitable for display on the local display. For example, the display module may convert the received visual data, which has a resolution of 320×320, to a higher resolution supported by the local display, such as 1280×720. In one embodiment, the display module 420 may transmit local configuration (or specification) to the mobile computing device 110 via the transmission module 410, such that the mobile computing device 110 generates and transmits to the peripheral display device 310 visual data suitable for display on the local display. In addition to displaying the received visual data on the local display, the display module 420 may also replay received audio data.

The input module 430 comprises a software or firmware instructions for receiving user inputs. The peripheral display device 310 may include (or connects to) one or more input devices such as a touch sensitive screen (not shown). The input module 430 may receive user inputs from the input devices and optionally transmit the user inputs to the mobile computing device 110 via the transmission module 410. The input module 430 may also receive signals from other sources. For example, a car-mounted display device may receive information such as fuel level and vehicle speed.

### Overview of Methodology

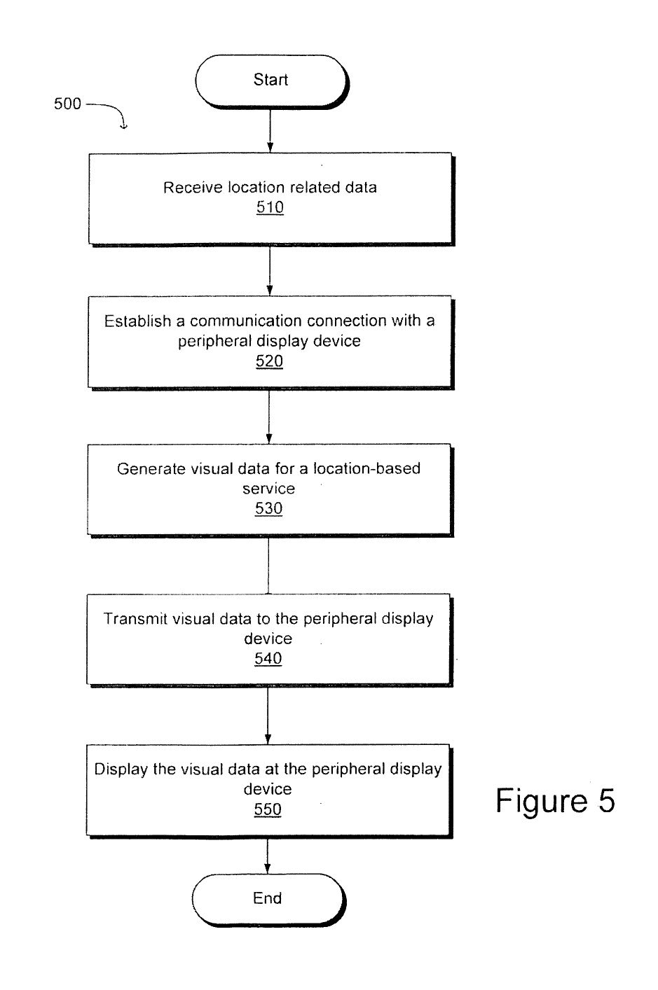

FIG. 5 is a flowchart illustrating an example method 500 for a computing device to provide a location-based service in a peripheral device. In one example, the computing device is the mobile computing devices 110 and the peripheral device is the peripheral display device 310. The steps of the method 500 are implemented by the central processor 220 executing software instructions that cause the described actions. One or more portions of the method 500 may be implemented in embodiments of hardware and/or software or combinations thereof. For example, instructions for performing the described actions are embodied or stored within a computer readable medium, e.g., the flash memory 214 or the RAM 216, and are executable by a processor, such as the central processor 220. Furthermore, those of skill in the art will recognize that other embodiments can perform the steps of FIG. 5 in different orders. Moreover, other embodiments can include different and/or additional steps than the ones described here.

Initially, the mobile computing device 110 receives 510 location (or position) related data. As detailed above with respect to FIG. 2, the mobile computing device 110 includes one or more components (e.g., a GPS receiver) for receiving 510 location-related signals (e.g., GPS signals). The mobile computing device 110 uses triangulation to determine its geographical position. The mobile computing device 110 may also receive 510 additional location-related data (e.g., map, traffic condition) from sources such as the Internet.

The mobile computing device 110 establishes 520 a communication connection with the peripheral display device 310. Examples of the communication connection include a Bluetooth connection and an infrared connection. In one embodiment, the mobile computing device 110 searches for compatible (or supported) peripheral devices located within its transmission range by sending out soliciting signals, and attempts to establish 520 the communication connection with those responding to the soliciting signals. In one embodiment, the mobile computing device 110 and/or the peripheral display device 310 authenticate the other device before establishing 520 the communication connection.

The mobile computing device 110 generates 530 visual data (e.g., graphical data, video data) for a location-based service. In one embodiment, the visual data is generated 530 for display on a local display of the mobile computing device 110 (e.g., the screen 130). Alternatively, the mobile computing device 110 generates 530 the visual data for the peripheral display device 310. In one embodiment, the mobile computing device 110 receives configuration (or specification) information (e.g., resolution, color supported) about the peripheral display device 310 via the established communication connection. The mobile computing device 110 may generate 530 (or convert) the visual data based on the configuration information.

The mobile computing device 110 transmits 540 the generated visual data to the peripheral display device 310 for display. In one embodiment, the mobile computing device 110 compresses the visual data to reduce the amount of data to be transmitted 540 (e.g., from BMP format to JPG format).

The peripheral display device 310 displays 550 the received visual data in a local display. In one embodiment, the peripheral display device 310 uncompresses the received visual data and converts them to a format suitable for local display. By reducing the size of the data transmission (via video compression), the mobile computing device 110 can transmit visual data at a high speed, thereby achieving real-time (or near real-time) display of visual data on the peripheral display device 310 as they are generated 530 on the mobile computing device 110.

The peripheral display device 310 may also receive user input and transmit the received input to the mobile computing device 110 via the communication connection. The mobile computing device 110 may update the visual data responding to the user input and transmit them to the peripheral display device 310.

### Example Process

The principles described herein can be further illustrated through an example operation of a mobile computing device in accordance with one embodiment of the invention. In this example, the mobile computing device is a web enabled smartphone with GPS capacity.

The smartphone receives 510 GPS signals and determines its latitude and longitude based on the GPS signals. The smartphone retrieves local map and traffic condition information from Google™ Maps via a mobile telecommunications network.

The smartphone detects and establishes 520 a communication connection with a dashboard-mounted display device on the user's automobile, and generates 530 a display of the local map and traffic based on a configuration of the dashboard-mounted display device. The smartphone transmits 540 the generated display to the dashboard-mounted display device, which displays 550 the map to the user.

The user may enter destination information using the dashboard-mounted display device (e.g., through a touch sensitive screen), which routes the information back to the smartphone. The smartphone calculates and generates routing information to be displayed on the dashboard-mounted display device, and provides turn-by-turn GPS guidance to the user via the dashboard-mounted display device based on real-time position information of the smartphone.

### Alternative Embodiments

In one embodiment, the mobile computing device 110 may transmit to the peripheral display device 310 information other than location-related data. For example, the mobile computing device 110 may provide time and/or date information to the peripheral display device 310, which may use it to synchronize its local clock or provide other functionalities (e.g., reduce brightness at night). The mobile computing device 110 may also provide other relevant information (e.g., reminders from automobile maintenance service providers) for the peripheral display device 310 to output.

In one embodiment, the peripheral display device 310 may receive information from sources other than user input. For example, if the peripheral display device 310 receives signals indicating that the fuel level is low, it may send the information to the mobile computing device 110, which may search for local gas stations and provide navigation information to the user via the peripheral display device 310.

Advantages of the disclosed embodiments include providing location-based services through existing peripheral devices with large viewing areas for use in vehicles such as cars and boats. The disclosed embodiments also beneficially keep the mobile device providing the services portable. Because the location-based services can be provided by the mobile device through existing peripheral devices, it is no longer necessary for users to obtain a separate device with large display for this purpose. In addition, because mobile computing devices often have access to users' personalized information, they may provide personalized location-based services through the peripheral devices.

Some portions of above description describe the embodiments in terms of algorithmic processes or operations. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for a mobile computing device to provide location-based services via a peripheral device. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method for a mobile computing device to provide location-based services via a peripheral device, the method comprising:
receiving location-related data at the mobile computing device;
establishing a communication connection between the mobile computing device and the peripheral device;
generating visual data for a location-based service by the mobile computing device, the visual data simultaneously viewable on a display of the mobile computing device; and
transmitting the generated visual data to the peripheral device for display.

2. The method of claim 1, wherein the mobile computing device is a smartphone.

3. The method of claim 2, wherein the peripheral device is a car-mounted display device.

4. The method of claim 3, wherein establishing the communication connection further comprises:
searching for peripheral devices located within a transmission range by sending out soliciting signals; and
authenticating a peripheral device responding to a soliciting signal.

5. The method of claim 3, wherein establishing the communication connection further comprises:
establishing the communication connection using Bluetooth or infrared.

6. The method of claim 3, wherein the location-related data includes GPS signals.

7. The method of claim 1, wherein receiving the location-related data further comprises:
retrieving the location-related data from the Internet; or
retrieving the location-related data from a local storage of the mobile computing device.

8. The method of claim 7, wherein transmitting the generated visual data to the peripheral device for display further comprises:
compressing the generated visual data; and
transmitting the compressed visual data to the peripheral device for display.

9. The method of claim 1, wherein generating the visual data for the location-based service further comprises:
generating audio data for the location-based service by the mobile computing device; and
transmitting the generated audio data to the peripheral device for playback.

10. The method of claim 1, wherein generating the visual data for the location-based service further comprises:
generating the visual data for the location-based service by the mobile computing device based on a configuration of a display of the peripheral device; and
displaying the generated visual data by the peripheral device on the display.

11. The method of claim 1, further comprising:
adjusting the generated visual data based on a configuration of a display of the peripheral device; and
displaying the generated visual data by the peripheral device on the display.

12. The method of claim 11, further comprising:
receiving a user input by the peripheral device;
transmitting the user input to the mobile computing device; and
responsive to the user input, the mobile computing device:
generating second visual data for the location-based service, and
transmitting the second visual data to the peripheral device for display.

13. The method of claim 12, wherein the location-based service includes street navigation service.

14. A computer readable medium with stored instructions, the instructions when executed by a processor cause the processor to perform a method comprising:
receiving location-related data at a mobile computing device;
establishing a communication connection between the mobile computing device and a peripheral device;
generating visual data for a location-based service by the mobile computing device, the visual data simultaneously viewable on a display of the mobile computing device; and
transmitting the generated visual data to the peripheral device for display.

15. The computer readable medium of claim 14, wherein the mobile computing device is a smartphone, the peripheral device is a car-mounted display device, and the location-related data includes GPS signals.

16. The computer readable medium of claim 15, wherein establishing the communication connection further comprises:
searching for peripheral devices located within a transmission range by sending out soliciting signals; and
authenticating a peripheral device responding to a soliciting signal.

17. The computer readable medium of claim 15, wherein establishing the communication connection further comprises:
establishing the communication connection using Bluetooth or infrared.

18. A mobile computing device, comprising:
a display;
a location module for receiving location-related data, the location module coupled with the display;
a service module for generating visual data for a location-based service, the service module coupled with the display, and the visual data is configured to be simultaneously viewable on the display; and
a communication module for establishing a communication connection with a peripheral device and transmitting the generated visual data to the peripheral device for display, the communication module coupled with the service module.

19. The mobile computing device of claim 18, wherein the mobile computing device is a smartphone, the peripheral device is a car-mounted display device, and the location-related data includes GPS signals.

20. The mobile computing device of claim 18, wherein the communication module is further configured for searching for peripheral devices located within a transmission range by sending out soliciting signals; and authenticating a peripheral device responding to a soliciting signal.
